(19) United States
(12) Patent Application Publication
(10) Pub. No.: US 2022/0143770 A1
(43) Pub. Date: May 12, 2022

(54) CUTTING FLUIDS

(71) Applicant: Hewlett-Packard Development Company, L.P., Spring, TX (US)

(72) Inventors: Kuan-Ting WU, Taipei City (TW); Qingyong GUO, Shanghai (CN); Chi HAO, Taipei City (TW)

(73) Assignee: Hewlett-Packard Development Company, L.P., Spring, TX (US)

(21) Appl. No.: 17/298,645

(22) PCT Filed: Jul. 26, 2019
(86) PCT No.: PCT/US2019/043545

§ 371 Date: May 31, 2021

(51) Int. Cl. B23Q 11/10; C10M 173/02

(52) U.S. Cl. CPC B23Q 11/1061; C10N 2040/22; C10M 2207/0215; C10M 173/02

(57) ABSTRACT

The present disclosure is drawn to a cutting fluid for use in computer numerical control milling. The cutting fluid can include from about 10 wt % to about 90 wt % of a C2 to C6 alcohol; from about 0.1 wt % to about 20 wt % of a chelating agent; from about 0.5 wt % to about 15 wt % of a metal ion selected from aluminum ion, chromium ion, nickel ion, tin ion, zinc ion, or a combination thereof; and from about 8.5 wt % to about 88.5 wt % water. The cutting fluid can have a surface tension that can range from about 22 dynes/cm to about 55 dynes/cm.

### BACKGROUND

The use of personal electronic devices of all types continues to increase. Cellular phones, including smartphones, have become nearly ubiquitous. Tablet computers have also become widely used in recent years. Portable laptop computers continue to be used by many for personal, entertainment, and business purposes. For portable electronic devices in particular, much effort has been expended to make these devices more useful and more powerful while at the same time making the devices smaller, lighter, and more durable.

### BRIEF DESCRIPTION OF THE DRAWINGS

FIG. 1 graphically illustrates an example cutting fluid in accordance with the present disclosure;

FIG. 2 graphically illustrates a schematic view of an example metal cutting system in accordance with the present disclosure; and

FIG. 3 is a flow diagram illustrating an example method of manufacturing a housing for an electronic device in accordance with the present disclosure.

### DETAILED DESCRIPTION

Computer numerical control (CNC) milling is a machined process that utilizes computer controls and rotating multi-point cutting tools to cut and shape a substrate and to produce custom designed parts and products, such as housings for electronic devices. Cutting fluids can be used during CNC milling to cool and/or lubricate metal work pieces. Cutting fluids can also improve tool life and the quality of finished part/product. However, cutting fluids utilized in CNC milling can include lubricants and/or oils that can leave behind a residue on the surface of the milled part or product. This residue can create stains, foggy spots, and/or can lead to corrosion; thereby, diminishing the aesthetic quality and/or durability of the milled part or product.

In accordance with this example and others, the present disclosure is drawn to a cutting fluid. The cutting fluid can include from about 10 wt % to about 90 wt % of a C2 to C6 alcohol; from about 0.1 wt % to about 20 wt % of a chelating agent; from about 0.5 wt % to about 15 wt % of a metal ion selected from aluminum ion, chromium ion, nickel ion, tin ion, zinc ion, or a combination thereof; and from about 8.5 wt % to about 88.5 wt % water. The cutting fluid can have a surface tension from about 22 dynes/cm to about 55 dynes/cm. In one example, the C2 to C6 alcohol can be ethanol, n-propanol, isopropanol, or a combination thereof. In another example, the C2 to C6 alcohol can be present at from about 30 wt % to about 50 wt %. In yet another example, the chelating agent can include phosphate, diethanolamine, diglycolamine, ethylenediamine, triethanolamine, borate, acetate, oxalate, glycol, glycerol, diethylene glycol, ethylenediaminetetraacetic acid disodium salt, sodium acetate, or a combination thereof. In a further example, the metal ion can be selected from zinc ion, aluminum ion, or a combination thereof.

In another example, a metal cutting system is presented. The metal cutting system can include a computer numerical control device with a diamond mill interface; and a cutting fluid that can have a surface tension from about 22 dynes/cm to about 55 dynes/cm to lubricate the diamond mill interface while milling. The cutting fluid can include from about 10 wt % to about 90 wt % of a C2 to C6 alcohol; from about 0.1 wt % to about 20 wt % of a chelating agent; from about 0.5 wt % to about 15 wt % of a metal ion selected from aluminum ion, chromium ion, nickel ion, tin ion, zinc ion, or a combination thereof; and from about 8.5 wt % to about 88.5 wt % water. In an example, the metal cutting system can further include a metal substrate to be milled by the diamond mill interface and the cutting fluid. In one example, the metal substrate can include a metal alloy of magnesium, aluminum, lithium, titanium, chromium, nickel, iron, steel, or a combination thereof. In another example, the metal substrate can have a thickness from about 0.3 mm to about 5 mm. In yet another example, the diamond mill interface can be a router bit, a saw blade, a boring bit, a shaper cutter, or a shaper bit.

Further presented herein is a method of manufacturing a housing for an electronic device comprising cutting a metal substrate with a computer numerical control mill while lubricating a diamond mill interface thereof with a cutting fluid. The cutting fluid can have a surface tension from about 22 dynes/cm to about 55 dynes/cm. The cutting fluid can include from about 10 wt % to about 90 wt % of a C2 to C6 alcohol; from about 0.1 wt % to about 20 wt % of a chelating agent; from about 0.5 wt % to about 15 wt % of a metal ion selected from aluminum ion, chromium ion, nickel ion, tin ion, zinc ion, or a combination thereof; and from about 8.5 wt % to about 88.5 wt % water. In one example, the method can further include electrodepositing a colorant on the metal substrate at a location where cutting has occurred on the metal substrate. In another example, prior to electrodepositing the colorant, the method can include removing the cutting fluid from the metal substrate by flowing oxygen, air, or nitrogen gas across a surface of the metal substrate. In yet another example, prior to cutting, the method can further include coating the metal substrate to form a coating layer thereon at an average thickness from about 5 μm to about 60 μm. The coating can be selected from a powder coating, a primer coating, a paint coating, or a combination thereof. Alternatively or in conjunction with, the method can further include after cutting but prior to electrodepositing the colorant, forming a passivation layer on the metal substrate by micro-arc oxidation at a thickness that can range from about 3 μm to about 25 μm. In a further example, a surface of the housing can have a gloss value of about 80 gloss units to 100 gloss units and a pencil hardness value of F to 3H.

It is noted that when discussing the cutting fluid, the metal substrate cutting system, or the method of manufacturing a housing for an electronic device, such discussions of one example are to be considered applicable to the other examples, whether or not they are explicitly discussed in the context of that example. Thus, in discussing a C2 to C6 alcohol in the context of the cutting fluid, such disclosure is also relevant to and directly supported in the context of the metal cutting system, the method of manufacturing a housing for an electronic device, and vice versa.

### Cutting Fluids

Cutting fluids as used herein include liquids used during computer numerical control (CNC) milling of metal substrates. A cutting fluid can reduce a temperature at a point of contact between the metal substrate and a rotating multi-point cutting tool of the CNC mill thereby reducing friction and decreasing an amount of heat generated, as well as, reducing a temperature via cooling. In addition, cutting fluids can remove debris formed during milling thereby providing a smoother surface finish and preventing tool galling.

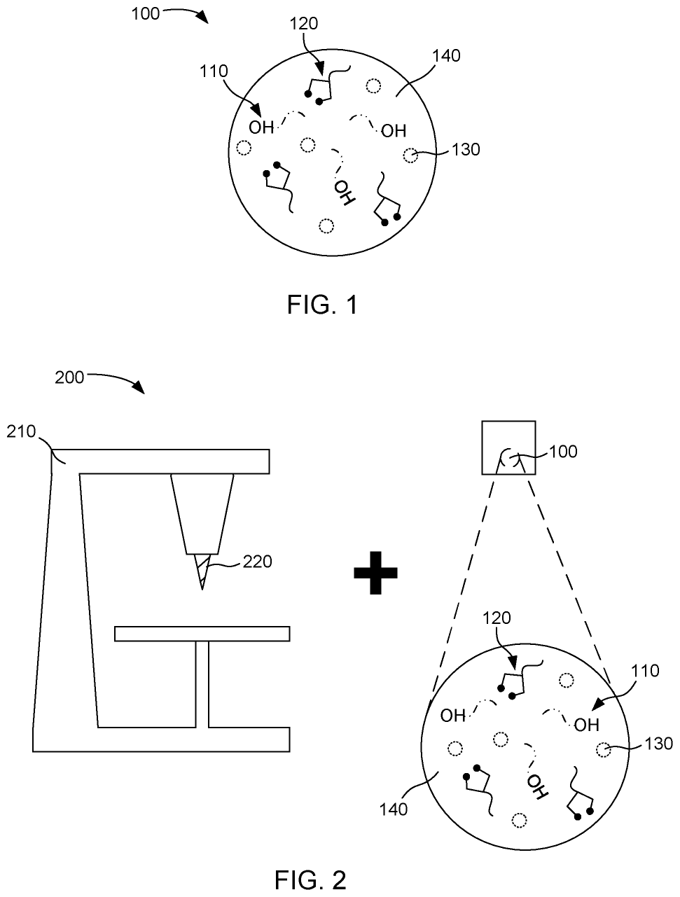

Cutting fluids presented herein can be water-soluble cutting fluids. In some examples, the cutting fluid can exclude oils. In one example, as illustrated in FIG. 1, a cutting fluid 100 can include from about 10 wt % to about 90 wt % of a C2 to C6 alcohol 110, from about 0.1 wt % to about 5 wt % of a chelating agent 120, from about 0.5 wt % to about 15 wt % of a metal ion 130 selected from aluminum ion, chromium ion, nickel ion, tin ion, zinc ion, or a combination thereof; and from about 8.5 wt % to about 88.5 wt % water 140. The components in the cutting fluid can be dissolved in the water.

Turning now to some example specifics of the cutting fluids of the present disclosure. The cutting fluid can include a C2 to C6 alcohol. For example, the alcohol can include ethanol, butanol, propanol, pentanol, hexanol, and isomers, or combinations thereof. In one example, the C2 to C6 alcohol can include ethanol. In another example, the C2 to C6 alcohol can include ethanol, propanol, isopropanol, or a combination thereof. In yet another example, the C2 to C5 alcohol can be an aromatic alcohol. For example, the C2 to C6 alcohol can include methyl cylcopropanol, cyclobutanol, cyclopropane-methanol, cyclopropyl ethanol, cyclobutane methanol, cyclopentanol, methyl pentanol, and the like. In further examples, the C2 to C6 alcohol can include functional elements such as chlorine, bromine, fluorine, iodine, potassium, or a combination thereof on sidechains of the alcohol. Examples of C2 to C6 alcohols with functional groups can include tribromo-ethanol, tricholoro-ethanol, sodium hydroxyacetate, dichloro-ethanol, bromo-ethanol, chloro-ethanol, fluoro-ethanol, iodo-ethanol, potassium isethionate, dibromo-propanol, dichloro-propanol, difluoro-propanol, bromo-propanol, chloro-propanol, fluoro-propanol, mercaptohexanol, and the like.

An amount of the C2 to C6 alcohol in the cutting fluid can vary from about 10 wt % to about 90 wt %. In some examples, an amount of the alcohol can vary from about 30 wt % to about 50 wt %, from about 20 wt % to about 60 wt %, from about 50 wt % to about 90 wt %, from about 10 wt % to about 70 wt %, or from about 25 wt % to about 75 wt %.

The cutting fluid can further include a chelating agent. The chelating agent can be selected from a phosphate, diethanolamine, diglycolamine, ethylenediamine, triethanolamine, borate, acetate, oxalate, glycol, glycerol, diethylene glycol, ethylenediaminetetraacetic acid disodium salt dihydrate, sodium acetate, or a combination thereof. In one example the chelating agent can include ethylenediamine, ethylenediaminetetraacetic acid disodium salt dihydrate, or a combination thereof. In another example, the chelating agent can include ethylenediamine.

The chelating agent can be present in the cutting fluid at from about 0.1 wt % to about 20 wt %. In yet other examples, the chelating agent can be present at from about 0.1 wt % to about 5 wt %, from about 0.5 wt % to about 7.5 wt %, from about 5 wt % to about 15 wt %, or from about 2 wt % to about 12 wt %.

The cutting fluid can further include a metal ion. The metal ion can be selected from an aluminum ion, a nickel ion, a chromium ion, a tin ion, a zinc ion, or a combination thereof. In one example, the metal ion can be selected from a zinc ion, an aluminum ion, or a combination thereof. In some examples, the metal ion can be present in the cutting fluid at from about 0.5 wt % to about 15 wt %. In yet other examples, the metal ion can be present at from about 1 wt % to about 10 wt %, from about 0.5 wt % to about 7.5 wt %, from about 5 wt % to about 15 wt %, or from about 2 wt % to about 12 wt %. The chelating agent and metal ion can collectively act to provide anti-corrosion resistance to a metal substrate being milled by a CNC mill.

The cutting fluid can further include water. In one example, the water can be deionized. Water can be present to balance. In some examples, water can be preset at from about 8.5 wt % to about 90 wt %, from about 50 wt % to about 70 wt %, from about 15 wt % to about 45 wt %, from about 40 wt % to about 80 wt %, or from about 30 wt % to about 60 wt %.

A surface tension of the cutting fluid can range from about 22 dynes/cm to about 55 dynes/cm. In another example, a surface tension of the cutting fluid can range from about 30 dynes/cm to about 40 dynes/cm. As used herein, “surface tension” can refer to an elastic tendency of a fluid at the surface. The surface tension can be related to an amount of water and alcohol in the cutting fluid. As the amount of alcohol decreases the surface tension increases. As the amount of alcohol increases the surface tension decreases. An example of this correlation is illustrated in Table 1, below.

TABLE 1
Surface Tension Correlation

| Water | Ethanol | Surface Tension |
|---|---|---|
| (wt %) | (wt %) | (dynes/cm) |
| 100 | 0 | 72.0 |
| 90 | 10 | 51.4 |
| 80 | 20 | 44.8 |
| 70 | 30 | 37.9 |
| 65 | 35 | 35.7 |
| 60 | 40 | 33.9 |
| 55 | 45 | 32.6 |
| 50 | 50 | 31.8 |
| 0 | 100 | 22.4 |

The ability to control surface tension of the cutting fluid can minimize sticking of the cutting fluid to the metal substrate. A cutting fluid having a lower surface tension can be blown away from the milled metal substrate and can thereby reduce residue formation on a milled part. The cutting fluid can have a basic pH. In one example, a pH of the cutting fluid can range from about 7.5 to about 12, from about 8 to about 12, from about 8.5 to about 11.5, or from about 8.5 to about 11.

In some examples, the cutting fluid can exclude components, such as carboxylic acids. In other examples, the cutting fluid can further include components such as carboxylate salts, such as sodium acetate at from about 2 wt % to about 15 wt %. The carboxylate salt can create a protective layer on the metal that can prevent corrosion of the metal for the 24 hours following milling. Even at basic pH levels, in some instances there can be some carboxylic acids in equilibrium with carboxylates, but the molar ratio of carboxylates to carboxylic acids in these examples can be greater than about 99:1, for example.

In other examples, the cutting fluid can further include an antimicrobial agent. Antimicrobial agents can include biocides and fungicides. Example antimicrobial agents can include the NUOSEPT® (Ashland Inc. (USA)), VANCIDE® (R. T. Vanderbilt Co. (USA)), ACTICIDE® B20 and ACTICIDE® M20 (Thor Chemicals (U.K.)), PROXEL® GXL (Arch Chemicals, Inc. (USA)), BARDAC® 2250, 2280, BARQUAT® 50-65B, and CARBOQUAT® 250-T, (Lonza Ltd. Corp. (Switzerland)), KORDEK® MLX (The Dow Chemical Co. (USA)), glutaraldehyde, and combinations thereof. In an example, a total amount of antimicrobial agents can range from about 0.1 wt % to about 1 wt %.

### Metal Cutting Systems

Further presented herein is a metal cutting system, 200 as shown in FIG. 2. The metal cutting system can include a computer numerical control device 210 with a diamond mill interface 220, and can also include a cutting fluid 100 that can have a surface tension from about 22 dynes/cm to about 55 dynes/cm to lubricate the diamond mill interface while milling. The cutting fluid can include from about 10 wt % to about 90 wt % of a C2 to C6 alcohol 110; from about 0.1 wt % to about 20 wt % of a chelating agent 120; from about 0.5 wt % to about 15 wt % of a metal ion 130 selected from aluminum ion, chromium ion, nickel ion, tin ion, zinc ion, or a combination thereof; and from about 8.5 wt % to about 88.5 wt % water 140.

### Computer Numerical Control Devices

In further detail, a computer numerical control (CNC) device can include a machine tool that can be automatically controlled through software embedded in a microcomputer electrically coupled to the machine tool. Milling by the machine tool can be directed based on computer-aided manufacturing software that can translate dimensions from a graphical design of the part or product to be produced. Machine tools of the computer numerical control device can vary. In one example, the machine tools can include a diamond mill interface. In an example, the diamond mill interface can include a router bit, a saw blade, a boring bit, a shaper cutter, or a shaper bit. Thus, a CNC milling device can be used for cutting, boring, and/or otherwise shaping a metal substrate on a computer numerical control mill while applying a cutting fluid. In one example, the milling can include a diamond cut. In this and other examples, the cutting fluid can be, for example, applied at from about 5 ml/min to about 150 ml/min. In other examples, the cutting fluid can be applied at from about 15 ml/min to about 90 ml/min, from about 30 ml/min to about 150 ml/min, from about 50 ml/min to about 100 ml/min or from about 5 ml/min to about 50 ml/min.

### Metal Substrates

In some examples, the metal cutting system can further include a metal substrate to be milled by the diamond mill interface and the cutting fluid. The metal can be an elemental metal, or more typically a metal alloy, and can include magnesium, aluminum, lithium, titanium, chromium, nickel, iron, steel, or a combination thereof. In one specific example, the metal substrate can be a light metal alloy substrate. The term “light metal” refers to metals and alloys that are generally any metal of relatively low density including metal that is less than about 5 g/cm³ in density. In some cases, light metal can be a material including aluminum, magnesium, titanium, lithium, niobium, zinc, and alloys thereof. That stated, the metal substrate can be stainless steel or other metal substrate. In one specific example, the metal substrate can include a magnesium alloy. In some other examples, the magnesium alloy can include AZ31B, AZ61, AZ60, AZ80, AM60B, LZ91, LZ14, ALZ691, AZ91D, or an alloy thereof. In yet another example, the metal substrate can include an aluminum alloy.

The metal substrate can have a thickness suitable for a particular type of electronic device. In some examples, a thickness can vary based on the metal substrate and the desired strength of the alloy for supporting electronic components of an electronic device. In one example, the metal substrate can have an average thickness that can range from about 0.3 mm to about 5 mm. As used herein, an “average thickness” indicates a numerical average of a cross-sectional size. In another example, the metal substrate can have an average thickness that can range from about 0.3 mm to about 2 mm. In yet other examples, the metal substrate can have an average thickness that can range from about 0.5 mm to about 2.5 mm, from about 1 mm to about 3 mm, from about 2 mm to about 4 mm, or from about 0.75 mm to about 1.5 mm.

### Method of Manufacturing a Housings for Electronic Devices

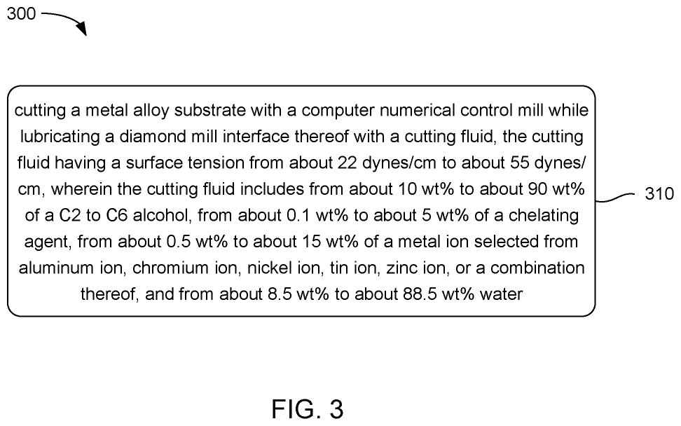

A method of manufacturing 300 a housing for an electronic device is shown at FIG. 3, and can include cutting 310 a metal substrate with a computer numerical control mill while lubricating a diamond mill interface thereof with a cutting fluid. The cutting fluid can have a surface tension from about 22 dynes/cm to about 55 dynes/cm. The cutting fluid can include from about 10 wt % to about 90 wt % of a C2 to C6 alcohol; from about 0.1 wt % to about 20 wt % of a chelating agent; from about 0.5 wt % to about 15 wt % of a metal ion selected from aluminum ion, chromium ion, nickel ion, tin ion, zinc ion, or a combination thereof; and from about 8.5 wt % to about 88.5 wt % water. The metal substrate, computer numerical control mill, and cutting fluid can be as described above.

In some examples, the method can further include electrodepositing a colorant on the metal substrate at a location where cutting has occurred on the metal substrate. In another example, prior to electrodepositing the colorant, the method can further include removing cutting fluid from the metal substrate by flowing oxygen, air, or nitrogen gas across a surface of the metal substrate.

In yet another example, the method can include prior to cutting, coating the metal substrate to form a coating layer thereon at an average thickness that can range from about 5 μm to about 60 μm prior to cutting. The coating can be selected from a powder coating, a primer coating, a paint coating, or a combination thereof. In a further example, after cutting but prior to electrodepositing the colorant, the method can further include forming a passivation layer on the metal substrate by micro-arc oxidation at a thickness from about 3 μm to about 25 μm.

In some examples, the method can include, micro-arc oxidation, passivation treatment, spray coating, transparent passivation treatment, and/or electrodepositing a colorant. In one example, the method can include micro-arc oxidation, followed by spray coating, followed by milling with a cutting fluid, followed by a transparent passivation treatment, followed by electrodepositing. In some examples, the previous method can be followed by a second milling, followed by a second transparent passivation treatment, and followed by second electrodepositing. In a further example, the previous method can be followed by a third milling, followed by a third transparent passivation treatment, and followed by third electrodepositing. The additional milling, transparent passivation treatments, and electrodepositing can allow for controlled electrodeposition of additional colorants at different portions of an electronic housing. The milling, transparent passivation treatment and electrodepositing of colorant can be repeated until a desired aesthetic appearance is achieved.

In some examples, the method can further include washing the metal substrate in preparation for various stages and between various stages in an ultrasonic deionized water bath. In yet other examples, the method can further include blowing a metal substrate after milling to remove a cutting fluid from a surface of the metal substrate. Each of the various stages in the method are discussed in further detail below.

### Micro-Arc Oxidation Treatment

Some metal substrates can be easily oxidized at the surface, and may be vulnerable to corrosion or other chemical reactions. For example, magnesium or magnesium alloys in particular can have a somewhat porous surface that can be vulnerable to chemical reactions and corrosion. Micro-arc oxidation can be used to form a protective layer at the surface of the metal substrate that can increase the chemical resistance, hardness, and durability of the metal substrate.

Micro-arc oxidation is an electrochemical process where a surface of a metal substrate is immersed in a chemical bath and treated using micro-discharges of compounds. The chemical bath can include water with from about 3 wt % to about 15 wt % of an electrolytic compound. The electrolytic compound can include sodium silicate, sodium phosphate, potassium fluoride, potassium hydroxide, sodium hydroxide, fluorozirconate, sodium hexametaphosphate, sodium fluoride, aluminum oxide, silicon dioxide, ferric ammonium oxalate, phosphoric acid salt, or any combinations thereof. A temperature of the chemical bath can range from about 20° C. to about 40° C. or from about 25° C. to about 35° C.

A high-voltage alternating current can be applied to the metal substrate and the metal substrate can effectively act as a working electrode. A high-voltage alternating current can also be applied to a counter electrode that can also be immersed in the chemical bath. The applied voltage can range from about 250 V to about 700 V. In yet other examples, the applied voltage can range from about 300 V to about 600 V, from about 250 V to about 500 V, or from about 400 V to about 700 V.

A time period of the submersion can correlate to a thickness of an oxidation layer formed thereon. In one example, the metal substrate can be submerged in the chemical bath for from about 5 minutes to about 20 minutes. In some examples, the oxidation layer formed on the metal substrate can have an average thickness that can range from about 3 μm to about 25 μm. In yet other examples, an average thickness of the oxidation layer formed thereon can range from about 5 μm to about 25 μm, from about 10 μm to about 20 μm, or from about 7 μm to about 15 μm.

### Passivation Treatment

In some examples, a passivation treatment can be applied to a surface of the metal substrate in place of micro-arc oxidation to form a protective passivation layer at the surface of the metal substrate. The metal can be submerged in a passivation chemical bath including a degreasing chemical bath.

The metal substrate can be subjected to the passivation treatment for a time period ranging from about 15 seconds to about 60 seconds. The time period of the treatment can correlate to a thickness of a passivation layer formed thereon. In some examples, the passivation layer formed on the metal substrate can have an average thickness that can range from about 1 μm to about 5 μm. In yet other examples, an average thickness of the passivation layer formed thereon can range from about 2 μm to about 5 μm, from about 1 μm to about 3 μm, or from about 3 μm to about 5 μm.

The passivation layer formed on the metal substrate can include a phosphate salt layer, a calcium phosphate layer, a molybdate layer, a vanadate layer, a phosphate layer, a chromate layer, a stannate layer, a manganese salt layer, or any combinations thereof.

### Ultrasonic Deionized Water Bath

In some examples, the metal substrate can be cleaned with deionized water. The deionized water can be heated at from about 15° C. to about 40° C. and placed in an ultrasonic bath. The ultrasonic bath can have a vibration rate of from about 10 kHz to about 200 kHz and the metal substrate can be submerged in the ultrasonic bath for a time period ranging from about 15 seconds to about 180 seconds.

### Spray Drying

In some examples, the method can include spray drying a metal substrate to remove a cutting fluid and/or water from the metal substrate following the milling and/or the cleaning with deionized water. The spray drying can involve, flowing a gas, oxygen, air, or nitrogen gas, across a surface of the metal substrate. The gas can be flowed at a gauge pressure of from about 25 psi to about 3,000 psi over a glossy surface area of the metal substrate. The spray drying can remove cutting fluid and prevent residual residue on the metal substrate.

### Coating

In some examples, housings described and prepared herein can include a coating (or application of coating), such as by application of a spray coating or electrostatically-applied coating to a surface of the metal. The coating can provide an aesthetic appeal and/or protection to the housing. Spray coating can be used to apply a primer coat, a base coat, a top coat, or a combination thereof. Electrostatic coating can be used to a powder coat.

Sprayed coatings can be applied as primer coatings, base coatings, top coatings, etc. A primer coat, for example, can include a polyester, polyurethane, or a combination thereof that can be applied to a surface of the metal substrate. The primer coat can be cured by baking the surface at a temperature that can range from about 60° C. to about 80° C. for a time period that can range from about 15 minutes to about 40 minutes. The primer coat can be applied at a thickness that can range from about 5 μm to about 20 μm.

A base coat can include polyester, polyurethane and polyurethane copolymers with pigments including carbon black, titanium dioxide, clay, mica, talc, barium sulfate, calcium carbonate, synthetic pigment, metallic powder, aluminum oxide, organic powder, inorganic powder, plastic bead, color pigment, dye, or any combination thereof. The base coat can be cured by baking the surface of the metal substrate at a temperature ranging from about 60° C. to about 80° C. for a time period ranging from about 15 minutes to about 40 minutes. The base coat can be applied at a thickness that can range from about 10 μm to about 20 μm.

A top coat can include a polyurethane coat and/or a ultra-violet coat. A polyurethane coat can include a polyurethane, a polyurethane copolymer, or both a polyurethane and a polyurethane copolymer. The polyurethane coat can be cured at a temperature that can range from about 60° C. to about 80° C. for a time period that can range from about 15 minutes to about 40 minutes. An ultra-violet coat can include a polyacrylic, a polyurethane, a urethane acrylate, an acrylic acrylate, an epoxy acrylate, or any combinations thereof. The ultra-violet coat can be cured at temperature that can range from about 50° C. to about 60° C., for a time period of from about 10 minutes to about 15 minutes, followed by UV exposure to a light having an energy ranging from about 700 mJ/cm² to about 1,200 mJ/cm² for from about 10 seconds to about 30 seconds. The polyurethane coat, the ultra-violet coat, or both the polyurethane coat and the ultra-violet coat can be independently applied at a thickness that can range from about 10 μm to about 25 μm.

The spray coating can be from about one layer thick to about four layers thick. In some examples, spray coating can include a primer coat, a base coat, and a top coat. In another example, spray coating can include a primer coat and a top coat. In yet another example, the coating can include a powder coat. In a further example, spray coating can include a top coat.

On the other hand, powder coat can include an epoxy, polyvinyl chloride, polyamides, polyesters, polyurethanes, acrylics, polyphenylene ether, or the like. The powder coat can be electrostatically applied to a surface of the metal substrate. In some examples applying a powder coat can include curing the surface of the metal substrate at a temperature ranging from about 120° C. to about 190° C. The powder coat can be applied at a thickness that can range from about 20 μm to about 60 μm.

### Transparent Passivation Treatment

A transparent passivation treatment can be used to form a transparent passivation layer at an exposed portion of a metal substrate following milling, cleaning, and/or spray drying of the metal substrate. Transparent passivation treatments may include immersing the metal substrate in a passivation treatment so that all surfaces of the metal substrate are contacted by reagents. However, in some examples, the passivation treatment may affect the exposed metal substrate while having no effect on surfaces of the metal substrate that have been coated or treated. In some examples, a transparent passivation layer may not be a discrete layer that is applied similarly to that of a spray coating, for example, but can become infused or otherwise become part of the metal substrate at or near a surface of the chambered edge.

A passivation treatment can include a chelating agent, a metal ion, a chelated metal complex, or a combination thereof. The chelating agent can include ethylenediaminetetraacetic acid; ethylenediamine; nitrilotriacetic acid; diethylenetriaminepenta (methylenephosphonic acid); nitrilotris(methylenephosphonic acid); 1-hydroxyethane-1,1-disphosphonic acid; phosphoric acid; or any combinations thereof. The metal ion can include an aluminum ion, an indium ion, a nickel ion, a chromium ion, a tin ion, or a zinc ion. The chelated metal complex can include a complex of a chelating agent and a metal ion. For example, the chelated metal complex can include a complex between zinc and ethylenediaminetetraacetic acid excluding ethylene glycol.

In some examples, a pH of the passivation treatment can range from about 3 to about 7. The metal substrate can be submerged in the passivation treatment for from about 30 seconds to 180 seconds. The transparent passivation layer formed can have an average thickness that can range from about 30 nm to about 1 μm, or from about 10 nm to about 1 μm.

Electrodepositing Colorant

In an example, electrodepositing a colorant can include cathodic or anodic electrodeposition. During electrodeposition the metal substrate can be submerged in an electrophoretic bath solution. The electrophoretic bath solution can include polyacrylic polymer, polyacrylamide-acrylic copolymer, epoxy-containing polymer, or any combinations thereof.

The electrophoretic bath solution can further include a colorant, a pigment, a dye or both, to be deposited on the metal substrate. Example pigments can include carbon black, titanium dioxide, clay, mica, aluminum powder, talc, barium sulfate, calcium carbonate, synthetic pigment, metallic powder, aluminum oxide, graphene, pearl pigment, or a combination thereof. Example dyes can include aluminum-based water-soluble dyes, tetraphenyldiamine-based water-soluble dyes, cyanine-based water-soluble dyes, dithiolene-based water-soluble dyes, ALEXA FLOUR™ 594 dye (available from ThermoFisher Scientific, USA), pacific orange, quinoline yellow WS, 3-carboxy-6,8-difluoro-7-hydroxycoumarin (aka pacific blue dye), or a combination thereof.

A charge can be applied to the electrophoretic bath solution that can range from about 30 V to about 150 V. The metal substrate can be submerged in the electrophoretic bath solution at from 30 seconds to about 120 seconds.

In some examples, the electrodeposition can be followed by curing. Curing the metal substrate can occur at a temperature that can range from about 120° C. to about 180° C. for a time period ranging from about 30 minutes to about 120 minutes.

As previously indicated, the method can be used to manufacture a housing for an electronic device. The housing can have a glossy or metallic luster surface. Glossy surfaces can be quantified in gloss units. As used herein, gloss units refer to an amount of light that is reflected off a surface of housing as measured by a gloss meter directed at a 60° angle to a surface of the housing. In one example, the housing can have a gloss value that can range from about 80 gloss units to about 100 gloss units. In yet other examples, a housing can have a gloss value that can range from about 85 gloss units to 95 gloss units or from about 80 gloss units to about 90 gloss units.

The housing can have a pencil hardness value of F to 3H. Pencil hardness is one way to quantify a hardness of the housing and can refer to the ability of a surface to resist scratching. Pencil hardness can be tested using ASTM D 3363, Standard Test Method for Film Hardness. The standard test method includes the following details: Pencil type: 6B-5B-4B-2B-B-HB-F-H-2H-3H-4H-5H-6H-7H-8H-9H (brand: Mitsubishi) with 6B being softest and 9H being hardest; Test Protocol: Force loading at 750 g; drawing lead sharpened; substrate placed on a level, firm, horizontal surface; starting with the hardest lead, hold the pencil or lead in holder firmly with the lead against the substrate layer at a 45° angle (point away from the operator) and push away from the operator; allow the load weight to apply uniform pressure downward and forward as the pencil is moved to either cut or scratch the substrate or to crumble the edge of the lead (length of stroke to be ¼ inch (6.5 mm); repeat process down the hardness scale until a pencil is found that will not scratch or gouge the substrate; the hardest pencil that does not scratch or gouge the substrate is then considered the pencil hardness of the substrate.

The housing can also have a durable surface that can exhibit high corrosion resistance. In some examples, the housing can pass a 96 hours salt fog test. A salt fog test can include spraying the multi-color electronic housing with a 5% salt solution for 24 hours, followed by drying for 24 hours, followed by a second spraying with the salt solution for 24 hours, and a second drying for 24 hours. The salt solution can have a temperature that can range from about 33° C. to about 37° C. In some examples, the salt fog test can comply with MIL-STD-810F environmental and engineering testing standard dated Jan. 1, 2000. As used herein, a passing result can occur when a housing does not exhibit visible corrosion following the 96 hours salt fog test.

The housing can be used to enclose and/or support and electronic component of any electronic device. In some examples, the housing can be a laptop housing, a desktop housing, a keyboard housing, a mouse housing, a printer housing, a smartphone housing, a tablet housing, a monitor housing, a television screen housing, a speaker housing, a game console housing, a video player housing, an audio player housing, or a combination thereof. The electronic device can be a laptop, a desktop, a keyboard, a mouse, a printer, a smartphone, a tablet, a monitor, a television, a speaker, a game console, a video player, an audio player, or a combination thereof.

### Definitions

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

As used herein, “housing” refers to the exterior shell of an electronic device. In other words, the housing contains the internal electronic components of the electronic device. The housing is an integral part of the electronic device. The term “housing” is not meant to refer to the type of removable protective cases that are often purchased separately for an electronic device (especially smartphones and tablets) and placed around the exterior of the electronic device.

As used herein, “colorant” can include dyes and/or pigments.

As used herein, “dye” refers to compounds or molecules that absorb electromagnetic radiation or certain wavelengths thereof. Dyes can impart a visible color to an ink if the dyes absorb wavelengths in the visible spectrum.

As used herein, “pigment” generally includes pigment colorants, magnetic particles, aluminas, silicas, and/or other ceramics, organo-metallics, or other opaque particles, whether or not such particles impart color. Thus though the present description primarily exemplifies the use of pigment colorants, the term “pigment” can be used more generally to describe pigment colorants and other pigments such as organometallics, ferrites, ceramics, etc. In one specific example, however, the pigment is a pigment colorant.

As used herein, a plurality of items, structural elements, compositional elements, and/or materials may be presented in a common list for convenience. However, these lists should be construed as though members of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if numerical values and sub-ranges is explicitly recited. For example, a weight ratio range of about 1 wt % to about 20 wt % should be interpreted to include not only the explicitly recited limits of 1 wt % and about 20 wt %, but also to include individual weights such as 2 wt %, 11 wt %, 14 wt %, and sub-ranges such as 10 wt % to 20 wt %, 5 wt % to 15 wt %, etc.

### Example

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

### Example

A computer numerical control cutting fluid was created by admixing the various components in Table 1.

TABLE 1
Cutting Fluid

| | Weight |
|---|---|
| Component | Percentage |
| Ethanol | 30 |
| Ethylenediamine | 12 |
| Ethylene Glycol | 4.5 |
| Water | 53.5 |

A surface tension of the cutting fluid was determined using a Fisherbrand™ Surface Tension Apparatus that determines surface tension from height of liquid in capillary tube. The cutting fluid exhibited a surface tension of about 32.5 dynes/cm.

The cutting fluid was applied at a rate of 75 mL/min during milling of a magnesium alloy on a computer numerical control mill. The cutting fluid was blown away using nitrogen gas at a gauge pressure of 330 psi over a glossy surface area of the metal substrate. The milled metal substrate did not include residual spots.

While the present technology has been described various modifications, changes, omissions, and substitutions can be made without departing from the spirit of the disclosure. It is intended, therefore, that the disclosure be limited by the scope of the following claims.

What is claimed is:

1. A cutting fluid comprising:
from about 10 wt % to about 90 wt % of a C2 to C6 alcohol;
from about 0.1 wt % to about 5 wt % of a chelating agent;
from about 0.5 wt % to about 15 wt % of a metal ion selected from aluminum ion, chromium ion, nickel ion, tin ion, zinc ion, or a combination thereof; and
from about 8.5 wt % to about 88.5 wt % water,
wherein the cutting fluid has a surface tension from about 22 dynes/cm to about 55 dynes/cm.

2. The cutting fluid of claim 1, wherein the C2 to C6 alcohol is ethanol, n-propanol, isopropanol, or a combination thereof.

3. The cutting fluid of claim 1, wherein the C2 to C6 alcohol is present at from about 30 wt % to about 50 wt %.

4. The cutting fluid of claim 1, wherein the chelating agent is phosphate, diethanolamine, diglycolamine, ethylenediamine, triethanolamine, borate, acetate, oxalate, glycol, glycerol, diethylene glycol, ethylenediaminetetraacetic acid disodium salt, sodium acetate, or a combination thereof.

5. The cutting fluid of claim 1, wherein the metal ion is selected from zinc ion, aluminum ion, or a combination thereof.

6. A metal cutting system comprising:
a computer numerical control device with a diamond mill interface; and
a cutting fluid having a surface tension from about 22 dynes/cm to about 55 dynes/cm to lubricate the diamond mill interface while milling, the cutting fluid including:
from about 10 wt % to about 90 wt % of a C2 to C6 alcohol,
from about 0.1 wt % to about 5 wt % of a chelating agent,
from about 0.5 wt % to about 15 wt % of a metal ion selected from aluminum ion, chromium ion, nickel ion, tin ion, zinc ion, or a combination thereof, and
from about 8.5 wt % to about 88.5 wt % water.

7. The metal cutting system of claim 6, further comprising a metal substrate to be milled by the diamond mill interface and the cutting fluid.

8. The metal cutting system of claim 7, wherein the metal substrate is a metal alloy of magnesium, aluminum, lithium, titanium, chromium, nickel, iron, steel, or a combination thereof.

9. The metal cutting system of claim 7, wherein the metal substrate has a thickness from about 0.3 mm to about 5 mm.

10. The metal cutting system of claim 6, wherein the diamond mill interface is a router bit, a saw blade, a boring bit, a shaper cutter, or a shaper bit.

11. A method of manufacturing a housing for an electronic device comprising cutting a metal substrate with a computer numerical control mill while lubricating a diamond mill interface thereof with a cutting fluid, the cutting fluid having a surface tension from about 22 dynes/cm to about 55 dynes/cm, wherein the cutting fluid includes:
from about 10 wt % to about 90 wt % of a C2 to C6 alcohol,
from about 0.1 wt % to about 5 wt % of a chelating agent,
from about 0.5 wt % to about 15 wt % of a metal ion selected from aluminum ion, chromium ion, nickel ion, tin ion, zinc ion, or a combination thereof, and
from about 8.5 wt % to about 88.5 wt % water.

12. The method of claim 11, further comprising electrodepositing a colorant on the metal substrate at a location where cutting has occurred on the metal substrate.

13. The method of claim 12, wherein prior to electrodepositing the colorant, the method includes removing cutting fluid from the metal substrate by flowing oxygen, air, or nitrogen gas across a surface of the metal substrate.

14. The method of claim 11, further comprising:
prior to cutting, coating the metal substrate to form a coating layer thereon at an average thickness from about 5 μm to about 60 μm, wherein the coating is selected from a powder coating, a primer coating, a paint coating, or a combination thereof;
after cutting but prior to electrodepositing the colorant, forming a passivation layer on the metal substrate by micro-arc oxidation at a thickness from about 3 μm to about 25 μm; or
both.

15. The method of claim 11, wherein a surface of the housing has a gloss value of about 80 gloss units to 100 gloss units and a pencil hardness value of F to 3H.
